(19) United States
(12) Patent Application Publication
(10) Pub. No.: US 2025/0184986 A1
(43) Pub. Date: Jun. 5, 2025

(54) BEAMFORMING CONTROL

(71) Applicant: Telefonaktiebolaget LM Ericsson (publ), Stockholm (SE)

(72) Inventors: Bengt-Erik OLSSON, Hovås (SE); Elias KAIPALEXIS, Göteborg (SE); Jens FREDRIKSSON, Sjömarken (SE)

(73) Assignee: Telefonaktiebolaget LM Ericsson (publ), Stockholm (SE)

(21) Appl. No.: 18/841,255

(22) PCT Filed: Feb. 24, 2022
(86) PCT No.: PCT/EP2022/054642

§ 371 Date: Aug. 23, 2024

(51) Int. Cl. H04W 72/044

(52) U.S. Cl. CPC H04W 72/046

(57) ABSTRACT

A method is disclosed for controlling beamforming of an antenna system comprising at least first and second antenna panels mounted in non-parallel planes, wherein each of the antenna panels is configured for beamforming transmission. The method comprises determining a first beam for transmission from the first antenna panel, and controlling the first antenna panel to use the first beam to transmit a first instantiation of a radio frequency signal. The method also comprises controlling the second antenna panel to use a second beam to transmit a second instantiation of the radio frequency signal simultaneously with the first beam transmission, wherein the second beam is configured to provide a spatial overlap between the first and second beams. In some embodiments, the method further comprises controlling at least one of the first and second antenna panels to use at least one additional beam to transmit an additional instantiation of the radio frequency signal simultaneously with the first and second beam transmissions, wherein the additional beam is configured to mitigate destructive combining between the first and second beams. Corresponding computer program product, apparatus, arrangement, radio access node, wireless communication device, control node, and wireless communication system are also disclosed.

### TECHNICAL FIELD

The present disclosure relates generally to the field of wireless communication. More particularly, it relates to control of beamforming for wireless communication.

### BACKGROUND

In some wireless communication systems, transmission beamforming is used to focus energy towards an intended receiver device. Examples include some cellular access radio networks (e.g., fifth generation, 5G, and sixth generation, 6G, wireless communication systems) and some systems configured to operate in unlicensed frequency bands (e.g., IEEE 802.11-based systems, such as WiGig).

Transmission beamforming may be accomplished by application of an antenna system (e.g., an antenna panel) comprising a plurality of antenna elements to provide one or more relatively narrow beam. Each beam may be used to direct energy towards a respective connected user (intended receiver device), and the beam direction may be dynamically changed to track the user when the user is mobile. An example antenna system suitable for transmission beamforming is a phase array antenna module (PAAM) that comprises a plurality of (relatively small) antenna elements that are controllable by programmable amplitude and phase controllers.

A benefit of transmission beamforming is that the fraction of transmitted power that reaches the intended receiver device is increased compared to a non-beamforming scenario (i.e., the transmission is more effective). Thus, the amount of energy used for transmission may be reduced and/or the coverage distance of the transmission may be increased, while performance of the transmission is kept unchanged. Another benefit of transmission beamforming is that the amount of interference caused by the transmission can be reduced.

A problem of transmission beamforming by antenna panels is that the quality of a beam produced by an antenna panel typically deteriorates when the angle between the beam direction and boresight of the antenna panel increases. For example, the (peak and/or total) antenna gain of a beam may decrease when the angle between the beam direction and boresight of the antenna panel increases. Alternatively or additionally, the shape of a beam (i.e., the spatial emission pattern) may be increasingly obstructed (e.g., increasingly asymmetric) when the angle between the beam direction and boresight of the antenna panel increases. This is cumbersome since variations in antenna gain and/or beam shape typically causes deteriorated coverage and/or beam tracking.

The problem might be overcome (or at least mitigated) by using multiple antenna panels facing different directions. Thereby, use of a beam of one antenna panel, which beam has a relatively large angle between the beam direction and boresight of the antenna panel, may be avoided by using a beam from another antenna panel instead, which beam has a relatively smaller angle between the beam direction and boresight of that antenna panel.

Typically, the problem is better mitigated the more antenna panels are used. However, use of many antenna panels has the problem of high cost and/or complexity. For example, each antenna panel entails a cost in itself. Furthermore, each antenna panel may require a corresponding radio unit (i.e., a scenario with many antenna panels infers that many radio units are needed), or a single radio unit needs to be configured to control multiple antenna panels (i.e., a scenario with many panels infers that a more complex radio unit us needed). Thus, there is a trade-off between beam quality and cost/complexity due to the number of antenna panels.

Therefore, there is a need for alternative approaches to transmission beamforming. For example, it would be desirable to enable improved beam quality compared to other approaches, while the extent of correspondingly induced cost/complexity increase is kept below that needed by the other approaches.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for controlling beamforming of an antenna system comprising at least first and second antenna panels mounted in non-parallel planes, wherein each of the antenna panels is configured for beamforming transmission.

The method comprises determining a first beam for transmission from the first antenna panel, and controlling the first antenna panel to use the first beam to transmit a first instantiation of a radio frequency signal.

The method also comprises controlling the second antenna panel to use a second beam to transmit a second instantiation of the radio frequency signal simultaneously with the first beam transmission, wherein the second beam is configured to provide a spatial overlap between the first and second beams.

In some embodiments, the first and second antenna panels are mounted adjacently to each other.

In some embodiments, the non-parallel planes are slanted relative each other by a mounting angle.

In some embodiments, the spatial overlap between the first second beams comprises a geographical overlap between coverage areas of the first and second beams.

In some embodiments, the second beam is configured to cause the first and second instantiations of the radio frequency signal to combine within the spatial overlap.

In some embodiments, the second beam is configured to cause the first and second instantiations of the radio frequency signal to combine constructively in at least a third direction.

In some embodiments, the first beam has a first direction that differs by a first angle from boresight of the first antenna panel and the second beam has a second direction that differs by a second angle from boresight of the second antenna panel, wherein the second direction is configured to cause the spatial overlap between the first and second beams.

In some embodiments, the second angle is configured to cause a difference between the first and second directions to fulfill a beam combining condition.

In some embodiments, the second antenna panel is controlled to use the second beam to transmit the second instantiation of the radio frequency signal only when the first angle fulfills a beam activation condition.

In some embodiments, a combined emission pattern of the first and second beams comprises emission pattern notches of destructive combination.

In some embodiments, the method further comprises controlling at least one of the first and second antenna panels to use at least one additional beam to transmit an additional instantiation of the radio frequency signal simultaneously with the first and second beam transmissions, wherein the additional beam is configured to mitigate destructive combining between the first and second beams.

In some embodiments, each additional beam has a respective direction that differs by a respective angle from boresight of the corresponding—first or second—antenna panel, and wherein the respective angle is configured to cause the mitigation of destructive combining.

In some embodiments, a number of additional beams and/or the respective direction for each additional beam is based on a transmission frequency.

In some embodiments, an angular spacing between possible beams becomes denser with increasing angle from boresight; for each of the first and second antenna panels.

In some embodiments, the first and second antenna panels are controlled by individual control signals.

In some embodiments, the first and second antenna panels are controlled by a single control signal.

In some embodiments, the first and second instantiations of the radio frequency signal are provided to the first and second antenna panels as a single radio frequency signal.

In some embodiments, the first and second antenna panels are identical, each having a first edge, wherein the first and second antenna panels are mounted to let the first edge of the first antenna panel be adjacent to the first edge of the second antenna panel.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for controlling beamforming of an antenna system comprising at least first and second antenna panels mounted in non-parallel planes, wherein each of the antenna panels is configured for beamforming transmission.

The apparatus comprises controlling circuitry configured to cause determination of a first beam for transmission from the first antenna panel, controlling of the first antenna panel to use the first beam to transmit a first instantiation of a radio frequency signal, and controlling of the second antenna panel to use a second beam to transmit a second instantiation of the radio frequency signal simultaneously with the first beam transmission, wherein the second beam is configured to provide a spatial overlap between the first and second beams.

A fourth aspect is an arrangement comprising the apparatus of to the third aspect and the antenna system.

A fifth aspect is a radio access node comprising the arrangement of the fourth aspect.

A sixth aspect is a wireless communication device comprising the arrangement of the fourth aspect.

A seventh aspect is a control node comprising the apparatus of the third aspect.

An eighth aspect is a wireless communication system comprising a radio access node and a control node, wherein the radio access node has an antenna system comprising at least first and second antenna panels mounted in non-parallel planes, each of the antenna panels being configured for beamforming transmission, and wherein the control node comprises the apparatus of the third aspect and is configured to control beamforming of the antenna system of the radio access node.

In some embodiments, any of the above aspects may additionally have features identical with or corresponding to any of the various features as explained above for any of the other aspects.

An advantage of some embodiments is that alternative approaches to transmission beamforming are provided.

An advantage of some embodiments is that coverage and/or beam tracking is improved compared to other approaches (e.g., with the same number of antenna panels). For example, an advantage of some embodiments is that more uniform beam coverage is provided compared to other approaches.

An advantage of some embodiments is that beam quality may be improved compared to other approaches (e.g., with the same number of antenna panels).

An advantage of some embodiments is that the cost/complexity may be reduced compared to other approaches (e.g., with the same beam quality). For example, an advantage of some embodiments is that fewer and/or less complex radio units are needed compared to other approaches. Alternatively or additionally, an advantage of some embodiments is that fewer antenna panels are needed compared to other approaches.

An advantage of some embodiments is that beam quality may be improved compared to other approaches, while the extent of correspondingly induced cost/complexity increase is kept below that needed by the other approaches (e.g., improved beam quality with the same number of antenna panels, or the same beam quality with fewer antenna panels).

An advantage of some embodiments is that the trade-off between beam quality and cost/complexity due to the number of antenna panels is less restrictive than for other approaches.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2 is a plot illustrating example beam combining according to some embodiments;

FIG. 3A is a schematic drawing illustrating an example antenna system according to some embodiments;

FIG. 3B is a schematic drawing illustrating an example antenna system according to some embodiments;

FIG. 4A is a schematic drawing illustrating an example antenna system according to some embodiments;

FIG. 4B is a schematic drawing illustrating an example antenna system according to some embodiments;

FIG. 5 is a schematic drawing illustrating an example scenario of angles for an antenna system according to some embodiments;

FIG. 6 is a schematic block diagram illustrating an example apparatus according to some embodiments;

FIG. 7 is a schematic block diagram illustrating an example wireless communication system according to some embodiments; and

FIG. 8 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

Generally, when a radio access node is referred to herein, it is meant to encompass any node configured to provide radio access. For example, a radio access node may be a cellular network base station (e.g., operating in accordance with Third Generation Partnership—3GPP—standardization), or an access point (AP) for operation in unlicensed frequency bands (e.g., operating in accordance with IEEE 802.11 standardization).

Also generally, when a wireless communication device is referred to herein, it is meant to encompass any device configured to provide wireless communication for a user. For example, a wireless communication device may be a user equipment (UE) for connection to a cellular network (e.g., operating in accordance with Third Generation Partnership—3GPP—standardization), or a station (STA) for operation in unlicensed frequency bands (e.g., operating in accordance with IEEE 802.11 standardization).

Also generally, when a control node is referred to herein, it is meant to encompass any node configured to control one or more other node(s) (such as radio access node(s)) or device(s) (such as wireless communication device(s)). For example, a control node may be a central node of a cellular network or a system operating in unlicensed frequency bands, or a server node of a cloud computing system.

In the following, embodiments will be described that provide alternative approaches to transmission beamforming.

Some embodiments may be particularly relevant for frequencies above 1 GHz, and even more particularly relevant for frequencies above 10 GHz. For such frequencies, beamforming may be especially attractive. It should be noted, however, that application of embodiments is not limited to such frequencies.

It should be noted that embodiments may be applicable in any suitable wireless communication scenario where beamforming is used (e.g., 3GPP new radio—NR).

According to some embodiments, beam quality is improved (e.g., in terms of antenna gain and/or beam shape) compared to other approaches, which in turn enables improved coverage and/or beam tracking. For example, the (peak and/or total) antenna gain may be increased compared to other approaches, and/or the spatial emission pattern may be less obstructed (e.g., less asymmetric; closer to symmetric) than for other approaches.

Alternatively or additionally, the extent of cost/complexity increase induced by beam quality improvement is lower, according to some embodiments, than the cost/complexity required for the other approaches. For example, the number of antenna panels may be reduced compared to other approaches, and/or the radio unit(s) may be less complex and/or fewer compared to other approaches.

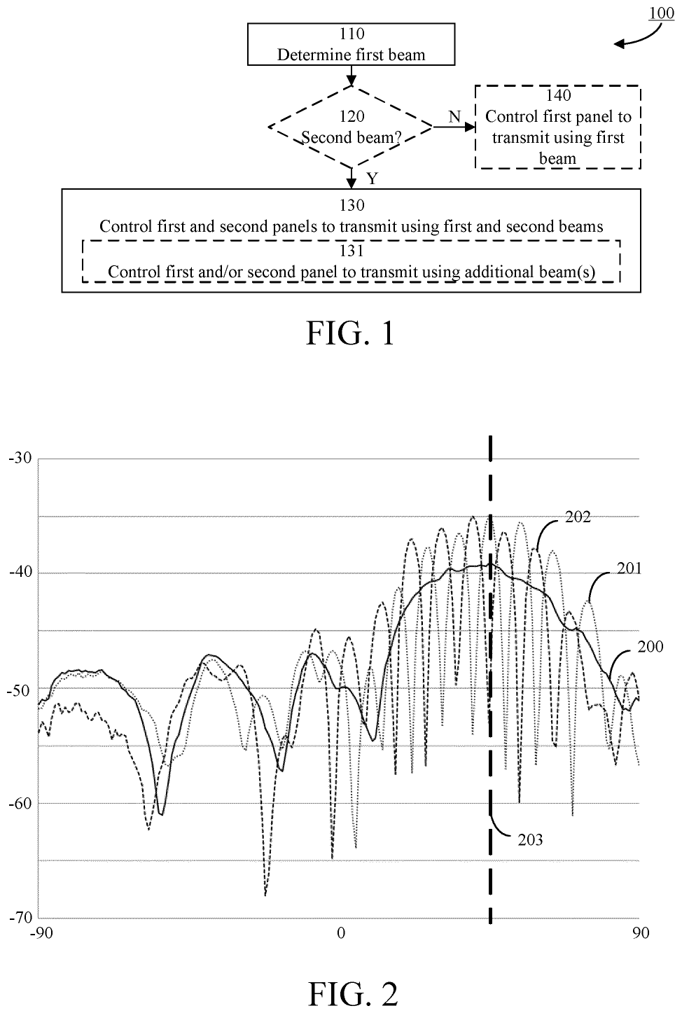

FIG. 1 illustrates an example method 100 according to some embodiments. The method 100 is a method for controlling beamforming of an antenna system. For example, the method 100 may be a method of controlling beamforming of an antenna system.

The antenna system comprises at least two (i.e., first and second) antenna panels. In some embodiments, the antenna system comprises more than two antenna panels (e.g., three, four, or a larger plurality or antenna panels). It should be understood that the features described herein for the first and second antenna panels may be equally applicable to any suitable pair of antenna panels among the at least two antenna panels.

Each of the antenna panels is configured for beamforming transmission. Each antenna panel may comprise a plurality of antenna elements that are controllable to collectively provide a directable transmission beam. Such control may be in accordance with any suitable approach. For example, each antenna panel may be configured for digital beamforming, or analog beamforming, or any suitable hybrid beamforming.

Generally, each antenna panel may comprise any suitable antenna module capable of generating a steerable beam. For example, each antenna panel may comprise a phase array antenna module (PAAM), or a reflector-based antenna device (e.g., applying a microelectromechanical system—MEMS—approach).

The first and second antenna panels are mounted in non-parallel planes. The non-parallel planes of the first and second antenna panels may be defined as first and second planes, respectively, which are slanted relative each other by a mounting angle. Typically, the mounting angle is non-zero. For example, the mounting angle may have an absolute value which exceeds a slanting threshold value. The slating threshold value may be any suitable value between zero degrees and 120 degrees, for example. In some embodiments, the mounting angle has an absolute value between zero (exclusive) and 120 degrees (inclusive).

The first and second antenna panels are typically mounted adjacently to each other. For example, the first and second antenna panels may be mounted with an edge of the first antenna panel being adjacent to an edge of the second antenna panel. Alternatively or additionally, the first and second antenna panels may be mounted with a corner of the first antenna panel being adjacent to a corner of the second antenna panel.

When the antenna system comprises more than two antenna panels, three or more antenna panels may be mounted with respective corners being adjacent to each other.

In some embodiments, the first and second antenna panels are identical. When the first and second antenna panels are identical and each has a first edge (and a second edge, typically opposing the first edge), the first and second antenna panels may be mounted to let the first edge of the first antenna panel be adjacent to the first edge of the second antenna panel (or to let the second edge of the first antenna panel be adjacent to the second edge of the second antenna panel).

The method 100 comprises determining a first beam for transmission from the first antenna panel, as illustrated by step 110. The first beam has a first direction that differs by a first angle from boresight of the first antenna panel.

The determination of the first beam may be according to any suitable beam selection approach. For example, the first beam may be selected to provide coverage for an intended receiver (e.g., located in the first direction).

The method 100 also comprises controlling the first antenna panel to use the first beam to transmit a first instantiation of a radio frequency (RF) signal, as illustrated by step 130 as well as by optional step 140.

Furthermore, the method 100 comprises controlling the second antenna panel to use a second beam to transmit a second instantiation of the radio frequency signal simultaneously with the first beam transmission, as illustrated by step 130. Thus, step 130 entails the same radio signal being transmitted (in the form of first and second instantiations) simultaneously by respective beams of the first and second antenna panels. The second beam has a second direction that differs by a second angle from boresight of the second antenna panel.

In some embodiments, the first and second antenna panels may be controlled by individual control signals (e.g., from individual radio units or from a shared radio unit; typically more complex than each of the individual radio units).

In some embodiments, the first and second antenna panels may be controlled by a single, common, control signal (e.g., from a shared radio unit; typically less complex than the shared radio unit of individual control signals). It should be noted that, in such embodiments, the first and second angles are typically identical.

It should be noted that, when the first and second antenna panels are controlled by a single, common, control signal, the first and second angles are typically identical. In such cases there is typically only a single direction for the first beam that can be paired with a second beam of the same direction (e.g., 45 degrees from boresight for a mounting angle of 90 degrees). However, even if exactly the same directions are not possible for the first and second beams, benefits may still be achieved by application of the second beam.

In some embodiments, particularly when a single control signal is used, the first and second instantiations of the radio frequency signal may be provided to the first and second antenna panels as a single radio frequency signal (e.g., from a shared radio unit).

Using a single control signal and/or a single radio frequency signal may be particularly relevant when the first and second antenna panels are identical and mounted to let the first edge of the first antenna panel be adjacent to the first edge of the second antenna panel.

In some embodiments, the second antenna panel is controlled to use the second beam to transmit the second instantiation of the radio frequency signal only when the first angle fulfills a beam activation condition. This is illustrated by optional step 120. When the beam activation condition is fulfilled (Y-path out of step 120), the method 100 proceeds to step 130 where the second beam is applied in addition to the first beam. When the beam activation condition is not fulfilled (N-path out of step 120), the method 100 proceeds to step 140 where the second beam is not applied.

The beam activation condition may be any suitable condition. For example, the beam activation condition may comprise the magnitude of the first angle exceeding a beam activation threshold value. The beam activation threshold value may be any suitable value between zero degrees and 90 degrees. Typically, the beam activation threshold value may be a value between 30 degrees and 45 degrees. Thus, the beam activation condition may cause the second beam to transmit the second instantiation of the radio frequency signal only when the first direction of the first beam is substantially different from boresight direction of the first antenna panel. Alternatively or additionally, the beam activation condition may comprise that spatial overlap is possible to achieve for the first angle. Yet alternatively or additionally, the beam activation condition may comprise that the first beam corresponds to one out of a collection of beam indices indicated as relevant for application of the second beam.

Generally, it should be understood that a direction of a beam, when referred to herein, is not limited to the direction of a single lobe beam or to the direction of a main lobe of an emission pattern. For example, when a beam has two or more lobes, the direction may refer to a direction of any of the lobes. Typically, but not necessarily, the direction of a lobe corresponds to a direction of peak emission for the lobe.

The second beam is configured to provide a spatial overlap between the first and second beams (e.g., a geographical overlap between coverage areas of the first and second beams), and is typically also configured to cause the first and second instantiations of the radio frequency signal to combine within the spatial overlap. For example, the second direction may be configured to cause the spatial overlap (and the combining) between the first and second beams.

Thus, the method 100 enables the same radio signal being transmitted simultaneously as first and second instantiations by respective beams of the first and second antenna panels, to provide a combination of the first and second instantiations of the radio signal within a spatial overlap.

Generally, a combination between two signals may be constructive or destructive; i.e., the first and second instantiations of the radio signal may combine constructively or destructively (possibly varying between different parts of the spatial overlap). For example, the nature of the combining (constructive or destructive) may depend on differences in the signal paths of different antenna elements (e.g., differences in distances over the air from antenna element to point of combination, and/or differences in wiring lengths from radio unit to antenna element) leading to phase variations that result in constructive or destructive combining.

For example, the second beam may be configured to cause the first and second instantiations of the radio frequency signal to combine constructively in at least one (third) direction. The third direction may be any suitable direction (e.g., a direction within the spatial overlap). In some embodiments, the third direction is the same direction as the first direction. Alternatively or additionally, the third direction may be the same direction as the second direction, or a direction between the first and second directions. Yet alternatively or additionally, the third direction may be a direction towards an intended receiver of the radio frequency signal.

In some embodiments, the second angle of the second beam (i.e., the second direction) is selected based on the first angle of the first beam (i.e., the first direction) under a condition that specifies the combination within the spatial overlap. In some embodiments, the second angle is configured to cause a difference between the first and second directions to fulfill a beam combining condition that entails the combination within the spatial overlap. For example, the second direction may be selected based on the first direction to cause the first and second beams to combine constructively in the third direction.

In some embodiments, the combination within the spatial overlap is achieved by selecting the second direction to be equal to the first direction, or substantially equal to the first direction (e.g., with an angular difference between the first and second directions, the magnitude of which is less than a difference threshold value). As will be demonstrated in connection with FIG. 5 for a typical scenario, the first and second direction are typically equal when a sum of magnitudes of the first and second angles equals the magnitude of the mounting angle.

Alternatively or additionally, the combination within the spatial overlap is achieved due to that the relative mounting of the first and second antenna panels enable that the first and second beams overlap at, or close to, a meeting point between the first and second antenna panels. This may be particularly relevant when the first and second directions are identical.

In some embodiments, the first and second instantiations of the radio frequency signal combine destructively to some extent (e.g., in some directions within the spatial overlap). For example, a combined emission pattern of the first and second beams may comprise emission pattern notches of destructive combination (e.g., within the spatial overlap). This may be problematic because a notch of destructive combination typically results in an area with very poor coverage within the spatial overlap.

To mitigate the drawbacks of destructive combining, one or more additional beam(s) may be used to transmit additional instantiation(s) of the radio frequency signal simultaneously with the first and second beam transmissions. An additional beam may be transmitted by the first antenna panel or by the second antenna panel.

Typically, the first antenna panel is controlled to use at least one additional beam (a third beam) to transmit an additional (third) instantiation of the radio frequency signal simultaneously with the first and second beam transmissions, and the second antenna panel is controlled to use at least one additional beam (a fourth beam) to transmit an additional (fourth) instantiation of the radio frequency signal simultaneously with the first and second beam transmissions.

More generally, the method 100 may comprise controlling at least one of the first and second antenna panels to use at least one additional beam to transmit an additional instantiation of the radio frequency signal simultaneously with the first and second beam transmissions, as illustrated by optional sub-step 131.

The additional beam(s) are configured to mitigate destructive combining between the first and second beams.

The mitigation may be achieved by configuring the additional beam(s) to provide a spatial overlap with the first and second beams, causing the additional instantiation(s) of the radio frequency signal to combine constructively with the first and second instantiations of the radio frequency signal within the spatial overlap. For example, the additional beam(s) may be constructed to place peak(s) in the combined emission pattern of the additional beam(s) at notch(es) of destructive interference in the combined emission pattern of the first and second beams.

Alternatively or additionally, the mitigation may be achieved by configuring each additional beam to have a respective direction that differs by a respective angle from boresight of the corresponding—first or second—antenna panel, and wherein the respective angle is configured to cause the mitigation of destructive combining. Typically, the respective angle(s) of the additional beam(s) of the first antenna panel are different from the first angle and the respective angle(s) of the additional beam(s) of the second antenna panel are different from the second angle. Further, when one antenna panel transmits more than one additional beam, the respective angles of those additional beams are typically different. It should be noted that, when the first and second antenna panels are controlled by a single, common, control signal, each pair of additional beams (one of each the first and second antenna panels) have respective angles that are typically identical.

For example, a look-up table may be used for selecting proper additional beam(s) based on the first and second beams.

As mentioned earlier, the nature of the combining (constructive or destructive) may depend on differences in the (length of) signal paths of different antenna elements leading to phase variations that result in constructive or destructive combining. Therefore, the pattern of destructive interference (e.g., where notch(es) of destructive interference occurs) may vary with differences in the signal paths, and the additional beam(s) may need to be adapted accordingly.

Furthermore, the pattern of destructive interference may vary with the transmission frequency (since a particular difference in signal path length corresponds to different phases for different transmission frequencies). Thus, in some scenarios, the destructive interference pattern may be dependent on the transmission frequency. Therefore, the additional beam(s) may be adapted based on the transmission frequency according to some embodiments. For example, the number of additional beams and/or the respective direction for each additional beam may be based on the transmission frequency. In some embodiments, a look-up table may be used for selecting proper additional beam(s) based on the first and second beams and on the transmission frequency. For situations where a relatively large bandwidth is used, digital beamforming may be used to select different directions in different parts of the bandwidth for an additional beam.

In some embodiments, an angular spacing between possible beams becomes denser with increasing angle from boresight for each of the first and second antenna panels. This has the advantage that additional beams—suitable for mitigation of destructive combining—may be available for scenarios with second beam transmission; which may typically be when the first angle has a relatively large magnitude (e.g., exceeding the beam activation threshold value as mentioned above). Additionally, an advantage is that—for scenarios without second beam transmission; which may typically be when the first angle has a relatively small magnitude (e.g., not exceeding the beam activation threshold value)—excessively dense beam spacing is avoided.

FIG. 2 is a plot illustrating example beam combining according to some embodiments. The example illustrated in FIG. 2 is for first and second antenna panels with a mounting angle of 90 degrees. The x-axis represents angular difference (in degrees) from boresight of the first antenna panel and the y-axis represents emission pattern power (in dBm). The emission pattern represented by 200 is for a first beam with a first angle magnitude of 45 degrees, and no second beam.

The emission pattern represented by 201 is for a combination of a first beam with a first angle magnitude of 45 degrees (e.g., a first angle of +45 degrees) and a second beam with a second angle magnitude of 45 degrees (e.g., a second angle of −45 degrees); the first and second directions being equal (compare with step 130 of FIG. 1). It can be seen, as illustrated at 203, that the emitted power at 45 degrees is higher for the emission pattern represented by 201 than for the emission pattern represented by 200.

The emission pattern represented by 202 is for a combination of an additional beam of the first antenna panel with a respective angle magnitude of 40 degrees (e.g., a respective angle of +40 degrees) and an additional beam of the second channel with a respective angle magnitude of 50 degrees (e.g., a respective angle of −50 degrees). It can be seen that combining the emission patterns represented by 201 and 202 mitigates the destructive combination notches of the emission pattern represented by 201, while still providing increased emitted power at 45 degrees compared to the emission pattern represented by 200 (compare with sub-step 131 of FIG. 1).

When the first and second antenna panels are controlled by a single, common, control signal, additional beams with the same respective angle magnitude (e.g., 42.5 degrees) may be used for both the first and second antenna panel.

Generally, the controlling of the first, second, and additional beams can be implemented directly (e.g., in software) for digital beamforming solutions where each antenna panel can be controlled individually, and for hybrid beamforming solutions where the antenna panels use analog beamforming but each antenna panel can be controlled individually.

Also generally, the controlling of the first, second, and additional beams can be implemented by using a single, common, control signal (and a single radio frequency signal) for all of the antenna panels when the orientation of adjacent (identical) antenna panels are flipped relative each other. Such an approach is suitable for any analog/hybrid beamforming solution where it is not possible to control the antenna panels individually, as well as for any beamforming solutions where each antenna panel can be controlled individually.

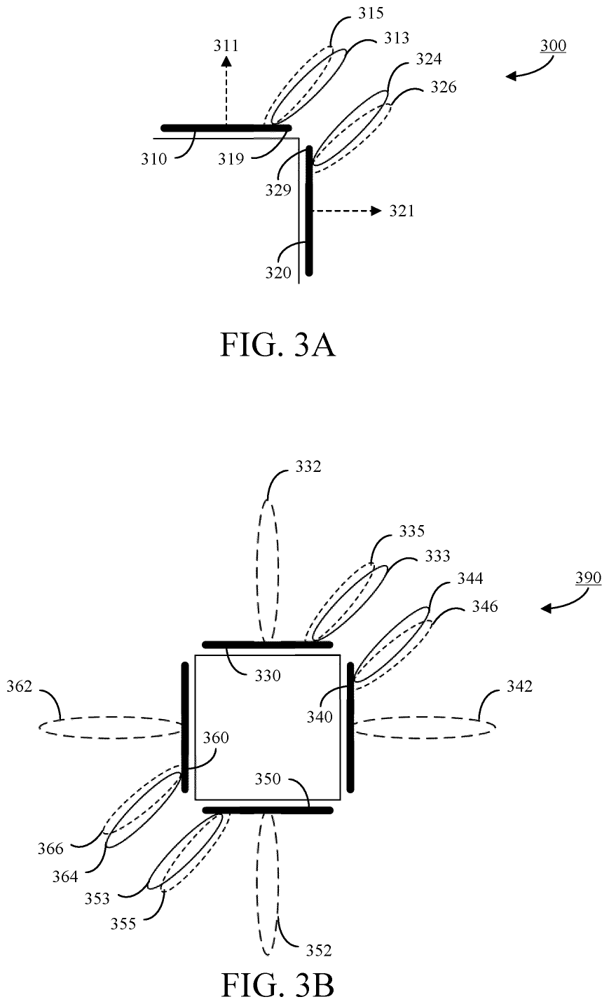

FIG. 3A schematically illustrates an example antenna system 300 according to some embodiments. For example, the antenna system 300 may be applicable in connection with the method 100 of FIG. 1 (i.e., the method 100 may be applied to control beamforming of the antenna system 300).

The antenna system comprises two antenna panels (each being configured for beamforming transmission); a first antenna panel 310 and a second antenna panel 320. The first and second antenna panels 310, 320 are mounted in non-parallel planes slanted relative each other by a mounting angle of 90 degrees. Furthermore, the first and second antenna panels 310, 320 are mounted adjacently to each other, with an edge 319 of the first antenna panel 310 being adjacent to an edge 329 of the second antenna panel 320.

If the first and second antenna panels 310, 320 are identical, the edges 319, 329 may be corresponding edges of the respective antenna panels 310, 320 (i.e., the orientations of the first and second antenna panels 310, 320 may be flipped relative each other; such that, if FIG. 3A represents a top view of the antenna system 300, an upward located edge of the second antenna panel 320 corresponds to a downward located edge of the first antenna panel 310).

Alternatively (regardless of whether the first and second antenna panels 310, 320 are identical or not), the edges 319, 329 may be opposite edges of the respective antenna panels 310, 320 (i.e., the orientations of the first and second antenna panels 310, 320 may be the same; such that, if FIG. 3A represents a top view of the antenna system 300, an upward located edge of the second antenna panel 320 corresponds to an upward located edge of the first antenna panel 310).

Other relations between the orientations of the first and second antenna panels 310, 320 are also possible, provided that the control is adapted accordingly.

A first beam 313 of the first antenna panel 310 may be used for transmission of a first instantiation of a radio frequency signal (compare with steps 130 and 140 of FIG. 1). The first beam 313 has a first direction that differs by a first angle from boresight 311 of the first antenna panel 310.

A second beam 324 of the second antenna panel 320 may be used for simultaneous transmission of a second instantiation of the radio frequency signal (compare with step 130 of FIG. 1). The second beam 324 has a second direction that differs by a second angle from boresight 321 of the second antenna panel 320.

The second beam 324 is configured to provide a spatial overlap between the first and second beams 313, 324 (e.g., as exemplified in connection to FIG. 1).

In some embodiments, the second antenna panel 320 uses the second beam 324 to transmit the second instantiation of the radio frequency signal only when the first angle of the first beam 313 fulfills a beam activation condition (compare with step 120 of FIG. 1). For example, the second antenna panel 320 may use the second beam 324 to transmit the second instantiation of the radio frequency signal only when the first direction of the first beam 313 differs from boresight 311 of the first antenna panel 310 by a first angle which exceeds a beam activation threshold value (e.g., 30, 35, or 40 degrees).

In some embodiments, the first and second instantiations of the radio frequency signal transmitted using the first and second beams 313, 324 combine destructively to some extent (e.g., as exemplified in connection to FIGS. 1 and 2). To mitigate the drawbacks of destructive combining, one or more additional beam(s) may be used to transmit additional instantiation(s) of the radio frequency signal simultaneously with the first and second beam transmissions (compare with sub-step 131 of FIG. 1).

This is exemplified in FIG. 3A by an additional beam 315 of the first antenna panel 310 and another additional beam 326 of the second antenna panel 320. The additional beam 315 has a slightly different direction than the first beam 313 and the additional beam 326 has a slightly different direction than the second beam 324.

The additional beams 315, 326 may be configured to combine (with each other, and with the first and second beams) within the spatial overlap between the first and second beams 313, 324, and to mitigate destructive combining between the first and second beams 313, 324.

In the example of FIG. 3A, the pair of additional beams 315, 326 has respective directions that are both closer to boresight 311, 321 than the direction of the first and second beams 313, 324, respectively. Alternatively, a pair of additional beams may have respective directions that are both farther away from boresight than the direction of the first and second beams, respectively. Yet alternatively, a pair of additional beams may have respective directions, wherein one additional beam direction is closer to boresight than the direction of the corresponding (first or second) beam, and the other additional beam direction is farther away from boresight than the direction of the corresponding (first or second) beam.

Furthermore, a pair of additional beams may have respective directions that each differs from the direction of the corresponding (first or second) beam by the same or different angle magnitude.

FIG. 3B schematically illustrates an example antenna system 390 according to some embodiments. For example, the antenna system 390 may be applicable in connection with the method 100 of FIG. 1 (i.e., the method 100 may be applied to control beamforming of the antenna system 390).

The antenna system comprises four antenna panels (each being configured for beamforming transmission); a first antenna panel 330, a second antenna panel 340, a third antenna panel 350, and a fourth antenna panel 360. Each adjacent pair of the antenna panels 330, 340, 350, 360 are mounted in non-parallel planes slanted relative each other by a mounting angle of 90 degrees.

If the antenna panels 330, 340, 350, 360 are identical, each pair of adjacent edges may be corresponding edges of the respective antenna panels (i.e., the orientations of the first and third antenna panels may be flipped relative the orientations of the second and fourth antenna panels; such that, if FIG. 3B represents a top view of the antenna system 390, an upward located edge of the second and fourth antenna panels 340, 360 corresponds to a downward located edge of the first and third antenna panels 330, 350).

Alternatively (regardless of whether the antenna panels 330, 340, 350, 360 are identical or not), each pair of adjacent edges may be opposite edges of the respective antenna panels (i.e., the orientations of all of the antenna panels 330, 340, 350, 360 may be the same).

Other relations between the orientations of the first and second antenna panels 310, 320 are also possible, provided that the control is adapted accordingly.

A first beam 333 of the first antenna panel 330 may be used for transmission of a first instantiation of a radio frequency signal (compare with steps 130 and 140 of FIG. 1, and the first beam 313 of FIG. 3A), and a second beam 344 of the second antenna panel 340 may be used for simultaneous transmission of a second instantiation of the radio frequency signal (compare with step 130 of FIG. 1, and the second beam 344 of FIG. 3A).

In some embodiments, the second antenna panel 340 uses the second beam 344 to transmit the second instantiation of the radio frequency signal only when the direction of the first beam 333 differs from boresight of the first antenna panel 330 by a first angle which exceeds a beam activation threshold value. Thus, when the first antenna panel 330 uses a beam 332 closer to boresight, the second antenna panel 340 is not used to provide a beam for spatial overlap with the beam 332.

Also illustrated in FIG. 3B are an additional beam 335 of the first antenna panel 330 and another additional beam 346 of the second antenna panel 340 (compare with the additional beams 315, 326 of FIG. 3A), which may be configured to mitigate destructive combining between the first and second beams 333, 344.

When the antenna panels 330, 340, 350, 360 are identical, and the orientations of the first and third antenna panels are flipped relative the orientations of the second and fourth antenna panels, all of the antenna panels 330, 340, 350, 360 may be controlled by a single, common, control signal and the radio frequency signal may be provided to the antenna panels 330, 340, 350, 360 as a single radio frequency signal. Doing so, the same transmission will take place from each of the antenna panels 330, 340, 350, 360.

Thus, using the first beam 333 for transmission from the first antenna panel 330 and the second beam 344 for transmission from the second antenna panel 340 would entail a third beam 353 being used for simultaneous transmission from the third antenna panel 330 and a fourth beam 364 being used for simultaneous transmission from the fourth antenna panel 360. Using the additional beams 335, 346 for transmission from the first and second antenna panels 330, 340 would entail corresponding additional beams 355, 366 being used for simultaneous transmission from the third and fourth antenna panels 350, 360.

Similarly, using the close-to-boresight beam 332 for transmission from the first antenna panel 330 would entail corresponding beams 342, 352, 362 being used for simultaneous transmission from the second, third, and fourth antenna panels 340, 350, 360, respectively.

Thus, using a single control signal and a single radio frequency signal for several antenna panels may yield transmission of surplus beams, that are typically not pointing towards the intended direction. In situations where the channel environment comprises radio frequency signal reflections (e.g., indoor scenarios), the surplus beams may improve coverage and/or received signal strength via reflection propagation paths.

In situations with transmission of surplus beams, it is typically not necessary to know which antenna panel faces the intended receiver to be able to determine the first beam, since the first and second beams are collectively selected together with the corresponding surplus beams.

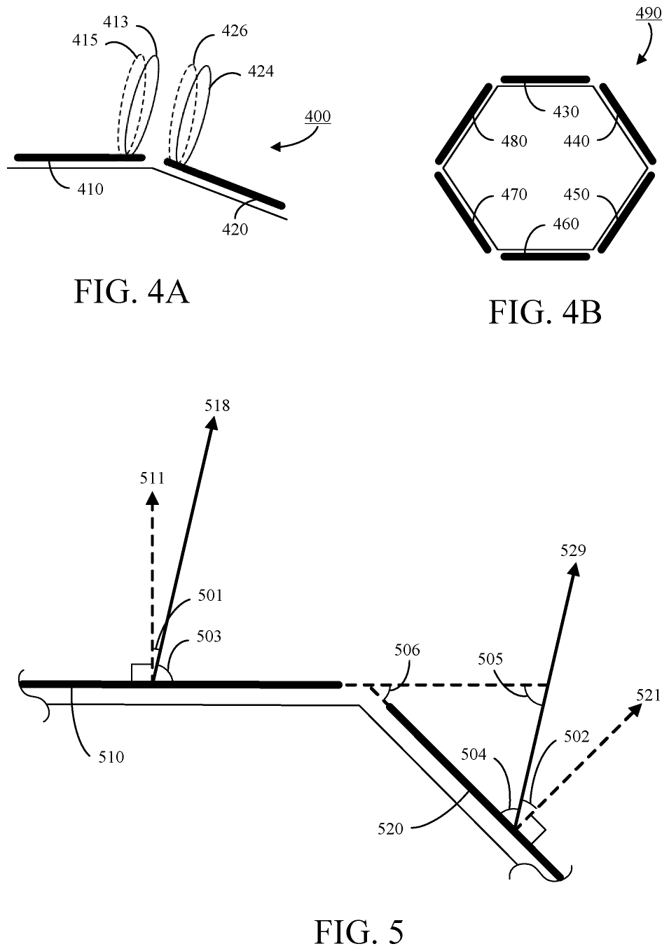

FIG. 4A schematically illustrates an example antenna system 400 according to some embodiments. For example, the antenna system 400 may be applicable in connection with the method 100 of FIG. 1 (i.e., the method 100 may be applied to control beamforming of the antenna system 400).

The antenna system comprises two antenna panels (each being configured for beamforming transmission); a first antenna panel 410 and a second antenna panel 420. The first and second antenna panels 410, 420 are mounted in non-parallel planes slanted relative each other by a mounting angle of less than 90 degrees. Furthermore, the first and second antenna panels 410, 420 are mounted adjacently to each other, with an edge of the first antenna panel 410 being adjacent to an edge of the second antenna panel 420.

If the first and second antenna panels 410, 420 are identical, the adjacent edges may be corresponding edges of the respective antenna panels 410, 420 (i.e., the orientations of the first and second antenna panels 410, 420 may be flipped relative each other).

Alternatively (regardless of whether the first and second antenna panels 410, 420 are identical or not), the adjacent edges may be opposite edges of the respective antenna panels 410, 420 (i.e., the orientations of the first and second antenna panels 410, 420 may be the same).

Other relations between the orientations of the first and second antenna panels 410, 420 are also possible, provided that the control is adapted accordingly.

A first beam 413 of the first antenna panel 410 may be used for transmission of a first instantiation of a radio frequency signal (compare with steps 130 and 140 of FIG. 1). The first beam 413 has a first direction that differs by a first angle from boresight of the first antenna panel 410.

A second beam 424 of the second antenna panel 420 may be used for simultaneous transmission of a second instantiation of the radio frequency signal (compare with step 130 of FIG. 1). The second beam 424 has a second direction that differs by a second angle from boresight of the second antenna panel 420.

The second beam 424 is configured to provide a spatial overlap between the first and second beams 413, 424 (e.g., as exemplified in connection to FIG. 1).

In some embodiments, the second antenna panel 420 uses the second beam 424 to transmit the second instantiation of the radio frequency signal only when the first angle of the first beam 413 fulfills a beam activation condition (compare with step 120 of FIG. 1).

In some embodiments, the first and second instantiations of the radio frequency signal transmitted using the first and second beams 413, 424 combine destructively to some extent (e.g., as exemplified in connection to FIGS. 1 and 2). To mitigate the drawbacks of destructive combining, one or more additional beam(s) may be used to transmit additional instantiation(s) of the radio frequency signal simultaneously with the first and second beam transmissions (compare with sub-step 131 of FIG. 1).

This is exemplified in FIG. 4A by an additional beam 415 of the first antenna panel 410 and another additional beam 426 of the second antenna panel 420. The additional beam 415 has a slightly different direction than the first beam 413 and the additional beam 426 has a slightly different direction than the second beam 424.

The additional beams 415, 426 may be configured to combine (with each other, and with the first and second beams) within the spatial overlap between the first and second beams 413, 424, and to mitigate destructive combining between the first and second beams 413, 424.

In the example of FIG. 4A, the direction of the additional beam 415 is closer to boresight than the direction of the first beam, and the direction of the additional beam 426 is farther away from boresight than the direction of the second beam.

FIG. 4B schematically illustrates an example antenna system 490 according to some embodiments. For example, the antenna system 490 may be applicable in connection with the method 100 of FIG. 1 (i.e., the method 100 may be applied to control beamforming of the antenna system 490).

The antenna system comprises six antenna panels 430, 440, 450, 460, 470, 480 (each being configured for beamforming transmission). Each adjacent pair of the antenna panels 430, 440, 450, 460, 470, 480 are mounted in non-parallel planes slanted relative each other by a mounting angle of 60 degrees.

If the antenna panels 430, 440, 450, 460, 470, 480 are identical, each pair of adjacent edges may be corresponding edges of the respective antenna panels (i.e., the orientations of the antenna panels 430, 450, and 470 may be flipped relative the orientations of the antenna panels 440, 460, 480).

Alternatively (regardless of whether the antenna panels 430, 440, 450, 460, 470, 480 are identical or not), each pair of adjacent edges may be opposite edges of the respective antenna panels (i.e., the orientations of all of the antenna panels 430, 440, 450, 460, 470, 480 may be the same).

Other relations between the orientations of the antenna panels 430, 440, 450, 460, 470, 480 are also possible, provided that the control is adapted accordingly.

First and second (and possibly additional and/or surplus) beams may be used in relation to the antenna system 490 in a similar manner as described for any of the FIGS. 3A, 3B, and 4A.

FIGS. 3A, 3B, 4A, 4B are meant to exemplify some different antenna systems that may be applicable in association with the approaches for beamforming control described herein (e.g., according to the method 100 of FIG. 1). However, the antenna systems of FIGS. 3A, 3B, 4A, 4B should be considered as illustrative examples only.

It should be understood that an antenna system which is applicable in association with the approaches for beamforming control described herein may comprise any suitable number of two or more antenna panels; with any suitable mounting angle(s) between pairs of (adjacent) antenna panels (same or different mounting angle(s) for different pairs).

Furthermore, even if the antenna systems of FIGS. 3A, 3B, 4A, 4B illustrate antenna panels configured to cooperate in only one angular dimension (e.g., a horizontal/azimuth dimension if FIGS. 3A, 3B, 4A, 4B represent top views of their respective antenna systems), it should be understood that an antenna system which is applicable in association with the approaches for beamforming control described herein may comprise antenna panels configured to cooperate in more than one angular dimension (e.g., a horizontal/azimuth dimension and a vertical/altitude dimension).

Hence, an antenna system which is applicable in association with the approaches for beamforming control described herein may comprise any number of two or more antenna panels mounted in any suitable geometric constellation. To exemplify, six (square) antenna panels may be mounted to form an antenna system with a cube structure, twelve (pentagonal) antenna panels may be mounted to form an antenna system with a dodecahedron structure, etc.

FIG. 5 illustrates an example scenario of angles for an antenna system according to some embodiments (compare, e.g., with the antenna systems 300 and 400 of FIGS. 3A and 4A, respectively).

FIG. 5 illustrates a first antenna panel 510 and a second antenna panel 520; mounted in non-parallel planes slanted relative each other by a mounting angle (z) 506. A first direction 518 differs by a first angle (x) 501 from boresight 511 of the first antenna panel 510, and a second direction 529 differs by a second angle (y) 502 from boresight 521 of the second antenna panel 520.

Trigonometry yields that the angle 503 equals 90 degrees minus the first angle 501 (i.e., 90−x), that the angle 504 equals 90 degrees minus the second angle 502 (i.e., 90−y), and that the sum of the angles 504, 505, and 506 equals 180 degrees. When the angles 503 and 505 are equal, the lines in which the first and second directions 518, 529 lie are parallel. Hence, selecting the second direction 529 to be equal to the first direction 518 corresponds to selecting the second angle 502 such that (90−x)+(90−y)+z=180, which simplifies to x+y=z (i.e., a sum of magnitudes of the first and second angles equals the magnitude of the mounting angle).

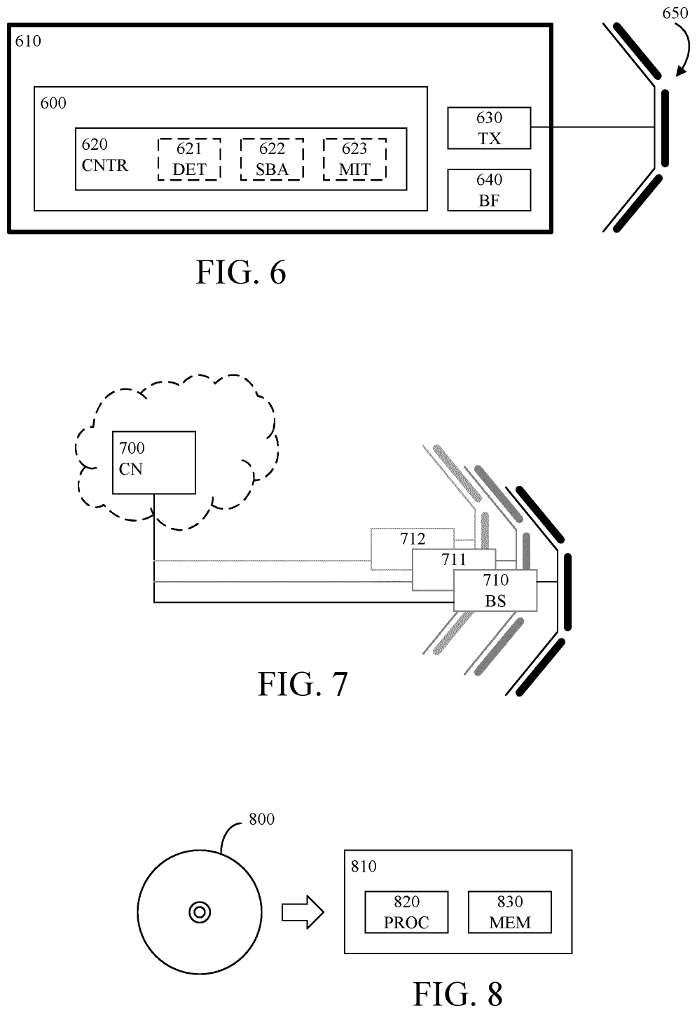

FIG. 6 schematically illustrates an example apparatus 600 according to some embodiments. The apparatus 600 for controlling beamforming of an antenna system. For example, the apparatus 600 may be configured to control beamforming of an antenna system 650.

The antenna system 650 comprises at least two (i.e., first and second) antenna panels. Each of the antenna panels is configured for beamforming transmission. The first and second antenna panels are mounted in non-parallel planes. For example, the antenna system may have any features as described earlier herein (e.g., in connection with FIGS. 1, 3A. 3B. 4A, and 4B).

In some embodiments, the antenna system 650 is comprised in, or otherwise associated with (e.g., connected, or connectable, to), a node/device 610 (e.g., a radio access node or a wireless communication device) that comprises the apparatus 600. Thus, an arrangement may comprise both the apparatus 600 and the antenna system 650.

In some embodiments, the antenna system is comprised in, or otherwise associated with (e.g., connected, or connectable, to), a node/device (e.g., a control node) that does not comprise the apparatus 600.

The apparatus 600 may, according to some embodiments, be configured to cause performance of (e.g., configured to perform) one or more steps of the method 100 described in connection with FIG. 1.

The apparatus 600 comprises a controller (CNTR; e.g., controlling circuitry or a control module) 620.

The controller 620 is configured to cause determination of a first beam for transmission from the first antenna panel (compare with step 110 of FIG. 1).

To this end, the controller 620 may comprise, or be otherwise associated with (e.g., connected, or connectable, to), a determiner (DET; e.g., determining circuitry or a determination module) 621. The determiner 621 may be configured to determine the first beam for transmission from the first antenna panel.

The controller 620 is also configured to cause controlling of the first antenna panel to use the first beam to transmit a first instantiation of a radio frequency signal (compare with steps 130 and 140 of FIG. 1).

To this end, the controller 620 may comprise, or be otherwise associated with (e.g., connected, or connectable, to), a beamformer (BF; e.g., beamforming circuitry or a beamforming module) 640. The beamformer 640 may be configured to control the first antenna panel to use the first beam to transmit the first instantiation of the radio frequency signal; typically by controlling of a transmitter (TX; e.g., transmitting circuitry or a transmission module) 630 connected, or connectable, to the antenna system 650.

The controller 620 is also configured to cause controlling of the second antenna panel to use a second beam to transmit a second instantiation of the radio frequency signal simultaneously with the first beam transmission (compare with step 130 of FIG. 1).

The second beam is configured to provide a spatial overlap between the first and second beams. For example, the second beam may have any features as described earlier herein (e.g., in connection with FIGS. 1, 3A, 3B, 4A, 4B, and 5).

Similarly as explained for the first beam, the determiner 621 may be configured to determine the second beam for transmission from the second antenna panel and/or the beamformer 640 may be configured to control the second antenna panel to use the second beam to transmit the second instantiation of the radio frequency signal.

The controller 620 may be configured to cause the second antenna panel to use the second beam to transmit the second instantiation of the radio frequency signal only when the first angle fulfills a beam activation condition (compare with step 120 of FIG. 1).

To this end, the controller 620 may comprise, or be otherwise associated with (e.g., connected, or connectable, to), a second beam activator (SBA; e.g., second beam activating circuitry or a second beam activation module) 622. The second beam activator 622 may be configured to cause (e.g., by controlling of the beamformer 640 to turn on or off the second beam) the second antenna panel to use the second beam to transmit the second instantiation of the radio frequency signal only when the first angle fulfills the beam activation condition.

In some embodiments, the controller 620 may be configured to cause controlling of at least one of the first and second antenna panels to use at least one additional beam to transmit an additional instantiation of the radio frequency signal simultaneously with the first and second beam transmissions.

Similarly as explained for the first and second beams, the determiner 621 may be configured to determine the additional beam(s) and/or the beamformer 640 may be configured to control the antenna panel(s) to use the additional beam(s) to transmit the additional instantiation(s) of the radio frequency signal.

The additional beam(s) is/are configured to mitigate destructive combining between the first and second beams. For example, the additional beam(s) may have any features as described earlier herein (e.g., in connection with FIGS. 1, 2, 3A, 3B, 4A, and 4B).

To this end, the controller 620 may comprise, or be otherwise associated with (e.g., connected, or connectable, to), a mitigator (MIT; e.g., mitigating circuitry or a mitigation module) 623. The mitigator 623 may be configured to cause (e.g., by controlling of the beam former 640 to turn on or off additional beam(s)) the antenna panel(s) to use the additional beam(s) to transmit the additional instantiation(s) of the radio frequency signal simultaneously with the first and second beam transmissions.

FIG. 7 schematically illustrates an example wireless communication system according to some embodiments.

The wireless communication system comprises one or more radio access node (s) 710, 711, 712. At least one (e.g., some, or each) of the radio access nodes 710, 711, 712 has an antenna system comprising at least first and second antenna panels mounted in non-parallel planes, wherein each of the antenna panels is configured for beamforming transmission. For example, the antenna system of a radio access node 710, 720, 730 may have any features as described earlier herein (e.g., in connection with FIGS. 1, 3A, 3B, 4A, and 4B).

The wireless communication system also comprises a control node (CN) 700 (e.g., a central node of a cellular network comprising the radio access node(s) 710, 720, 730, or a server node of a cloud computing system). The control node 700 is configured to control beamforming of the antenna system(s) of the radio access node(s) 710, 720, 730. For example, the control node 700 may comprise the apparatus 600 as described in connection with FIG. 6. Alternatively or additionally, the control node 700 may be configured to cause performance of (e.g., configured to perform) one or more steps of the method 100 described in connection with FIG. 1.

Generally, it should be noted that any feature explained or exemplified in connection to any one of the FIGS. 1, 2, 3A, 3B, 4A, 4B, 5, 6, and 7 may be equally applicable—as suitable—to any other one of the FIGS. 1, 2, 3A, 3B, 4A, 4B, 5, 6, and 7; even if not explicitly mentioned in connection thereto.

With reference to the above exemplifications, it is concluded that some embodiments provide an approach wherein the “outer” beams—i.e., beams with relatively high angular difference from boresight—from two (or more) antenna panels cooperate to create a combined beam with higher antenna gain than the individual beams.

The combination of beams may lead to some distortion (e.g., due to destructive combining), which can be mitigated by using additional beams in approximately the same direction. Typically, an increased number of additional beams enables improved mitigation.

To enable proper tuning of directions for the second and/or additional beams, the beamforming of the antenna panels may be configured to provide available beams more densely spaced when the angular difference from boresight is relatively high than when the angular difference from boresight is relatively low.

According to some embodiments, improvement in coverage may be achieved (e.g., more uniform coverage) compared to other approaches. Alternatively or additionally, in some embodiments, fewer antenna panels may be needed compared to other approaches.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a radio access node, a wireless communication device, or a control node.

Embodiments may appear within an electronic apparatus (such as a radio access node, a wireless communication device, or a control node) comprising arrangements, circuitry, and/or logic according to any of the embodiments described herein. Alternatively or additionally, an electronic apparatus (such as a radio access node, a wireless communication device, or a control node) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 8 illustrates an example computer readable medium in the form of a compact disc (CD) ROM 800. The computer readable medium has stored thereon a computer program comprising program instructions. The computer program is loadable into a data processor (PROC; e.g., a data processing unit) 820, which may, for example, be comprised in an apparatus (such as a radio access node, a wireless communication device, or a control node) 810. When loaded into the data processor, the computer program may be stored in a memory (MEM) 830 associated with, or comprised in, the data processor. According to some embodiments, the computer program may, when loaded into, and run by, the data processor, cause execution of method steps described herein (e.g., according to the method illustrated in FIG. 1).

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method for controlling beamforming of an antenna system comprising at least first and second antenna panels mounted in non-parallel planes, wherein each of the antenna panels is configured for beamforming transmission, the method comprising:
determining a first beam for transmission from the first antenna panel;
controlling the first antenna panel to use the first beam to transmit a first instantiation of a radio frequency signal; and
controlling the second antenna panel to use a second beam to transmit a second instantiation of the radio frequency signal simultaneously with the first beam transmission, wherein the second beam is configured to provide a spatial overlap between the first and second beams.

2. The method of claim 1, wherein the first and second antenna panels are mounted adjacently to each other.

3. The method of claim 1, wherein the non-parallel planes are slanted relative each other by a mounting angle.

4. The method of claim 1, wherein the spatial overlap between the first second beams comprises a geographical overlap between coverage areas of the first and second beams.

5. The method of claim 1, wherein the second beam is configured to cause the first and second instantiations of the radio frequency signal to combine within the spatial overlap.

6. The method of claim 5, wherein the second beam is configured to cause the first and second instantiations of the radio frequency signal to combine constructively in at least a third direction.

7. The method of claim 1, wherein the first beam has a first direction that differs by a first angle from boresight of the first antenna panel and the second beam has a second direction that differs by a second angle from boresight of the second antenna panel, and wherein the second direction is configured to cause the spatial overlap between the first and second beams.

8. The method of claim 7, wherein the second angle is configured to cause a difference between the first and second directions to fulfill a beam combining condition.

9. The method of claim 7, wherein the second antenna panel is controlled to use the second beam to transmit the second instantiation of the radio frequency signal only when the first angle fulfills a beam activation condition.

10. The method of claim 1, wherein a combined emission pattern of the first and second beams comprises emission pattern notches of destructive combination.

11. The method of claim 1, further comprising controlling at least one of the first and second antenna panels to use at least one additional beam to transmit an additional instantiation of the radio frequency signal simultaneously with the first and second beam transmissions, wherein the additional beam is configured to mitigate destructive combining between the first and second beams.

12. The method of claim 11, wherein each additional beam has a respective direction that differs by a respective angle from boresight of the corresponding—first or second—antenna panel, and wherein the respective angle is configured to cause the mitigation of destructive combining.

13. The method of claim 11, wherein a number of additional beams and/or the respective direction for each additional beam is based on a transmission frequency.

14. The method of claim 1, wherein—for each of the first and second antenna panels—an angular spacing between possible beams becomes denser with increasing angle from boresight.

15. The method of claim 1, wherein the first and second antenna panels are controlled by individual control signals.

16. The method of claim 1, wherein the first and second antenna panels are controlled by a single control signal.

17. The method of claim 16, wherein the first and second instantiations of the radio frequency signal are provided to the first and second antenna panels as a single radio frequency signal.

18. The method of claim 1, wherein the first and second antenna panels are identical, each having a first edge, and wherein the first and second antenna panels are mounted to let the first edge of the first antenna panel be adjacent to the first edge of the second antenna panel.

19. A computer program product comprising a non-transitory computer readable medium, having thereon a computer program comprising program instructions, the computer program being loadable into a data processing unit and configured to cause execution of a method for controlling beamforming of an antenna system comprising at least first and second antenna panels mounted in non-parallel planes, wherein each of the antenna panels is configured for beamforming transmission, the method comprising:
determining a first beam for transmission from the first antenna panel:
controlling the first antenna panel to use the first beam to transmit a first instantiation of a radio frequency signal; and
controlling the second antenna panel to use a second beam to transmit a second instantiation of the radio frequency signal simultaneously with the first beam transmission, wherein the second beam is configured to provide a spatial overlap between the first and second beams.

20. An apparatus for controlling beamforming of an antenna system comprising at least first and second antenna panels mounted in non-parallel planes, wherein each of the antenna panels is configured for beamforming transmission, the apparatus comprising:
a memory; and
controlling circuitry coupled to the memory, wherein the apparatus is configured to:
determine a first beam for transmission from the first antenna panel;
control the first antenna panel to use the first beam to transmit a first instantiation of a radio frequency signal; and
control the second antenna panel to use a second beam to transmit a second instantiation of the radio frequency signal simultaneously with the first beam transmission, wherein the second beam is configured to provide a spatial overlap between the first and second beams.

21-42. (canceled)
